(19) United States
(12) Patent Application Publication
(10) Pub. No.: US 2006/0208476 A1
(43) Pub. Date: Sep. 21, 2006

(54) Mud flap bracket

(76) Inventors: Rodney Collins, Walton, KY (US); Elijah Collins, Walton, KY (US)

Correspondence Address: FROST BROWN TODD, LLC, 2200 PNC CENTER, 201 E. FIFTH STREET, CINCINNATI, OH, 45202, US

(21) Appl. No.: 11/376,403

(22) Filed: Mar. 15, 2006

Related U.S. Application Data
(60) Provisional application No. 60/662,429, filed on Mar. 16, 2005.

(51) Int. Cl. B62D 25/18

(52) U.S. Cl. 280/851

(57) ABSTRACT

A mud flap assembly lends itself to a field installed kit by including two opposing flanges with inwardly opposing hooked edges that are drawn together by bolted vertical plates to grip a lower plate of a lateral I-beam prevalently used on semi-tractor trailers. Thereby, simple tools may be used even in austere locations in order to replace an OEM mud flap and mud flap attachment that are damaged, such as when a tire blows off its tread. Thereby, problems are avoided such as receiving a ticket for violating traffic regulations, becoming liable for damage due to road debris impacting other vehicles, and incurring lost time costs if grounded at a state border weigh station pending repair.

### CROSS REFERENCE TO RELATED APPLICATION

The present application claims the benefit of U.S. Pat Appln. Ser. No. 60/662,429 of the same title filed Mar. 16, 2005, the disclosure of which is hereby incorporated by reference in its entirety.

### FIELD OF THE INVENTION

The present invention relates, in general, to devices that attach a mud flap to a truck.

### BACKGROUND OF THE INVENTION

Semi-tractor trailers utilize a large number of tires at relatively high pneumatic pressure. Often these tires are retreaded for economic reasons. Over the numerous miles driven on these tires, occasionally a tire will shed its tread taking out the adjacent mud flap and its attachment. Reinstalling a mud flap along the roadside or other remote location is often difficult due to the range in types of mud flap attachments and specialized equipment required for their installation (e.g., welding equipment). However, driving without a mud flap subjects the driver to being ticketed, to being liable for road debris damage to other vehicles, and to lost time when grounded at locations such as state border weigh stations until repaired.

Consequently, a significant need exists for a mud flap bracket that has application to at least a large number of trucks and trailers that may be readily attached in an austere environment with simple tools.

### SUMMARY OF THE INVENTION

The invention overcomes the above-noted and other deficiencies of the prior art by providing a mud flap bracket, installed by use of a simple hand tool, that is configured to grip lateral I-beam supports that are prevalent in many vehicles and vehicle trailers. Moreover, there are two cooperatively engaging flange clips that are drawn together by at least one fastener to handle a range of I-beams demensions.

These and other objects and advantages of the present invention shall be made apparent from the accompanying drawings and the description thereof.

### BRIEF DESCRIPTION OF THE FIGURES

The accompanying drawings, which are incorporated in and constitute a part of this specification, illustrate embodiments of the invention, and, together with the general description of the invention given above, and the detailed description of the embodiments given below, serve to explain the principles of the present invention.

FIG. 1 is a perspective view of a mud flap assembly including a two-piece mud flap bracket bolted to a mud flap and gripping one of a plurality of lateral I-beam supports under a semi-tractor trailer.

FIG. 2 is a perspective view of disassembled interior sides of the two-piece mud flap bracket of FIG. 1.

FIG. 3 is a perspective view of the mud flap assembly and a portion of the attached I-beam of FIG. 1.

FIG. 4 is a side view of the mud flap assembly and attached I-beam of FIG. 1.

FIG. 5 is a side view of the mud flap assembly of FIG. 1 attached to an enlarged I-beam.

FIG. 6 is a side view of an alternate two piece mud flap bracket for mud flap assembly of FIG. 1.

### DESCRIPTION OF THE INVENTION

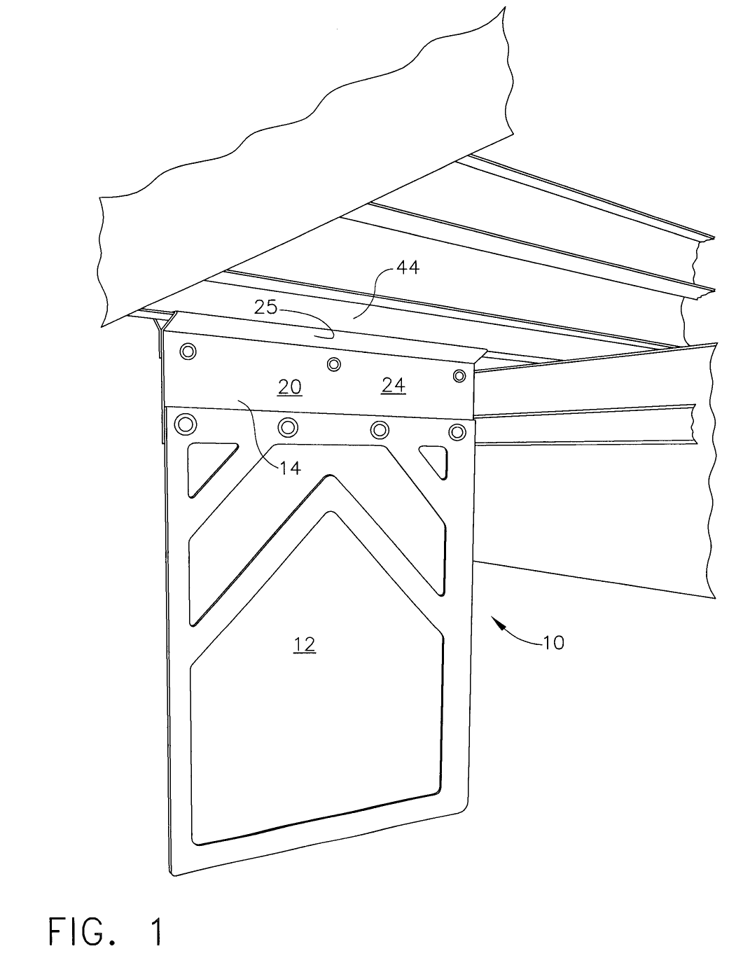

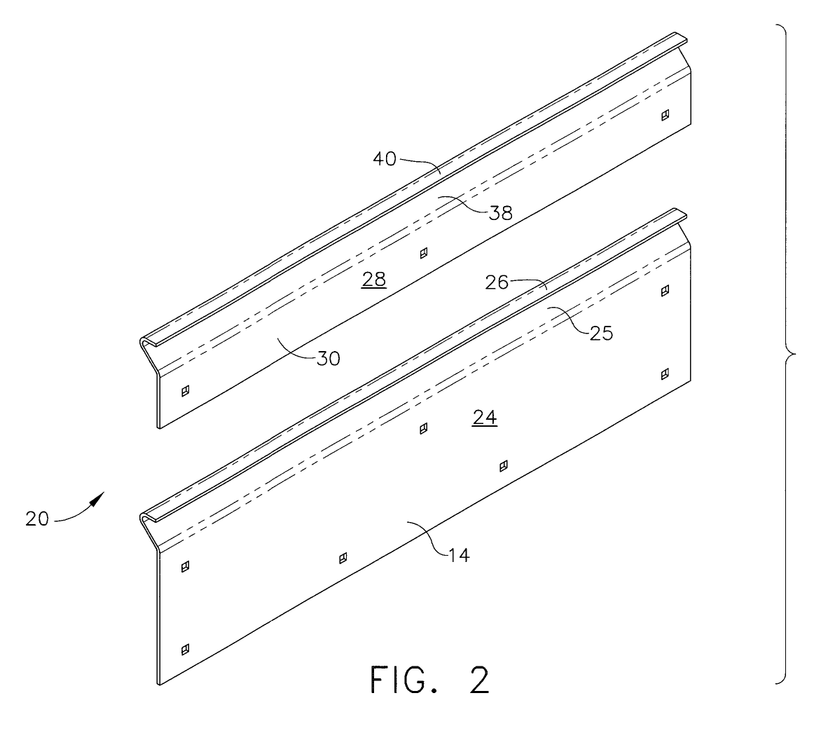

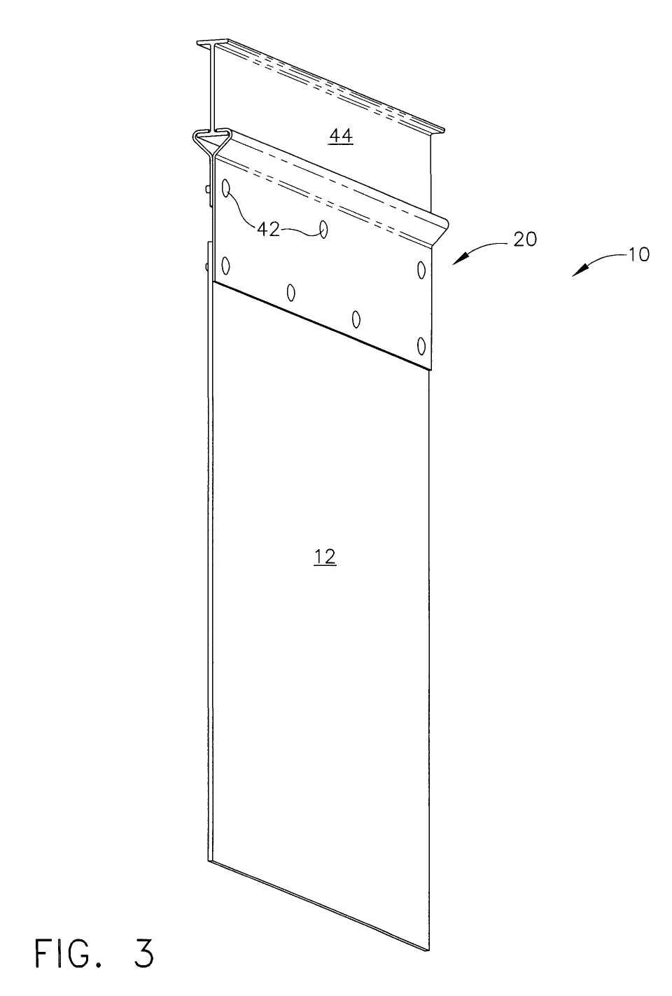

In FIGS. 1-5, a mud flap assembly 10 includes a mud flap 12, its upper portion overlapped and bolted to a vertical lower portion 14 of a two-piece mud flap bracket 20. In particular, the lower portion 14 is part of a first bracket member 24 that is bent along its horizontal width near its top into an acute angle from the vertical (e.g., 45° degrees) to form an outwardly extending portion 25 and then is bent again along its horizontal width closer yet to its top back in the other direction to form a near horizontal gripping flange 26. It should be appreciated that these angles may be formed by bending sheet metal, extruding a material in this shape, or by other fabrication techniques that include assembling a plurality of components.

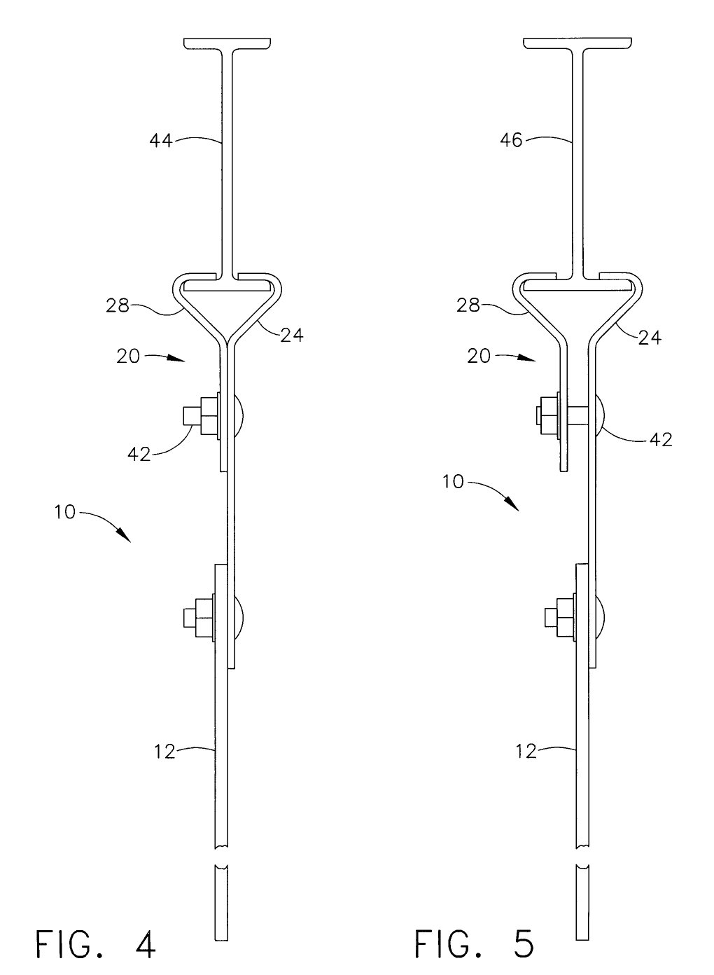

A second bracket member 28 includes a shorter vertical portion 30 that parallels the vertical lower portion 14 of the first bracket member 24 between the top edge of the mud flap 12 and the first bend (outwardly extending portion 25) in the first bracket member 24. The second bracket member 28 has a mirror image first bend along its horizontal width (e.g., 45° degrees) to form an outwardly extending portion 38 departing from the other first bracket member 24. The upper edge of outwardly extending portion 38 is then bent back to form a near horizontal gripping flange 40 opposing the near horizontal flange 26. Bolts 42 draw together the lower portion 14 of the first bracket member 24 and the shorter vertical portion 30 of the second bracket member 28 together along this parallel, proximate portion, whether fully together for a smaller I-beam 44 as depicted in FIG. 4 or a larger I-beam 46 as depicted in FIG. 5.

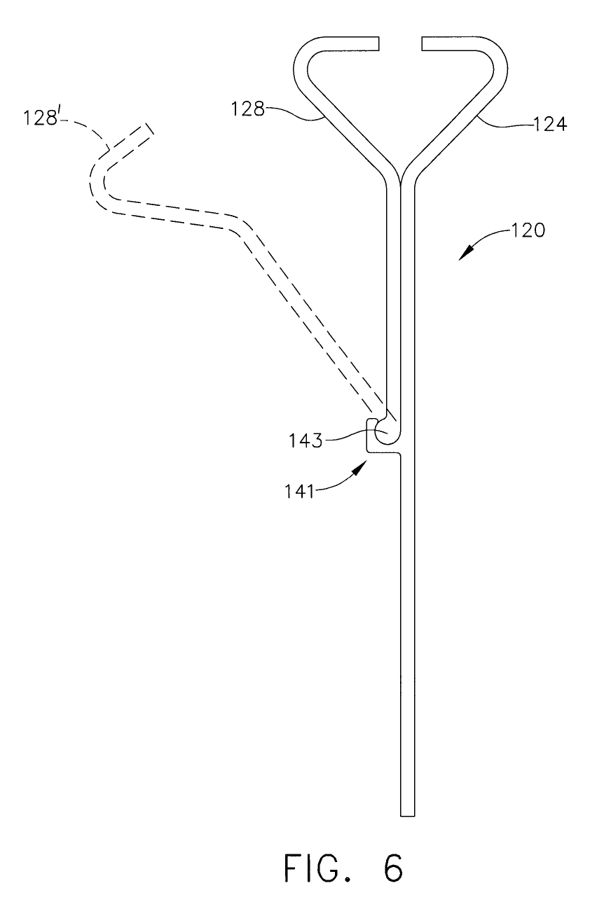

In FIG. 6, an alternate two-piece mud flap bracket 120, attachable to the mud flap 12 and I-beams 44, 46 depicted above, advantageously includes a pivoting attachment between a first bracket member 124 that is bent along its horizontal width near its top into an acute angle from the vertical (e.g., 45° degrees) to form an outwardly extending portion 125. It is then bent again along its horizontal width closer yet to its top back in the other direction to form a near horizontal gripping flange 126. It should be appreciated that these angles may be formed by bending sheet metal, extruding a material in this shape, or by other fabrication techniques that include assembling a plurality of components.

A second bracket member 128 includes a shorter vertical portion 130 that parallels a vertical lower portion 114 of the first bracket member 124 between the top edge of the mud flap 12 and the first bend (outwardly extending portion 125) in the first bracket member 124. The second bracket member 128 has a mirror image first bend along its horizontal width (e.g., 45° degrees) to form an outwardly extending portion 138 departing from the other first bracket member 124. The upper edge of outwardly extending portion 138 then is bent back to form a near horizontal gripping flange 140 opposing the near horizontal flange 126. An upwardly open pin pivot fixture 141 extends from the vertical lower portion 114 of the first bracket member 124 to downwardly capture a transverse pin 143 formed into a bottom edge of the second bracket member 128. An upper bolt or similar attachment (e.g., clip) hold together the lower portion 114 of the first bracket member 124 and the shorter vertical portion 10 of the second bracket member 128 together about the pivotal connection between the pivot fixture 141 and transverse pin 143, whether fully together for the smaller I-beam 44 as depicted in FIG. 4 or the larger I-beam 46 as depicted in FIG. 5. This adjustability is suggested by a detached configuration with the second bracket member, depicted in phantom at 128′ pivoted away from the first bracket member.

It should be appreciated that the pivotal connection between the two bracket members 124, 128 may be formed such that the pin pivot fixture may be formed sufficiently around the transverse pin 143 to prevent detachment.

While the present invention has been illustrated by description of several embodiments and while the illustrative embodiments have been described in considerable detail, it is not the intention of the applicant to restrict or in any way limit the scope of the appended claims to such detail. Additional advantages and modifications may readily appear to those skilled in the art. For example, both portions of a mud flap bracket may be identical with the mud flap bolted between their lower parallel portions, perhaps with the brackets being deformable to accommodate I-beams of varying thicknesses.

Applications consistent with the present invention may form gripping portions having a different geometric shape, such as a half-cylindrical shape.

What is claimed is:

1. A device, comprising:
a first member comprising a lower vertical plate sized to attach to an upper portion of a mud flap formed and comprising an upper outwardly extending portion with an upper gripping flange;
a second member comprising a lower vertical plate attachable to the lower vertical plate of the first member and comprising an upper outwardly extending portion with an upper gripping flange; and
attachments drawing the lower vertical plates of the first and second members to cause the opposing upper gripping flanges to engage a lower horizontal plate of an I-beam support.

2. The device of claim 1, further comprising a mud flap bolted to at least the lower vertical plate of the first member.

3. The device of claim 1, wherein the attachments comprise bolts and nuts sized to space the lower vertical plates of the first and second member to engage an enlarged I-beam lower horizontal plate.

4. The device of claim 1, wherein the attachments comprise a lower pivotal attachment between the first and second members and a fastener attached between the first and second members.

5. The device of claim 4, wherein the pivotal attachment comprises a pin guide extending from the first member capturing a transverse pin at a lower end of the second member.

6. The device of claim 5, wherein the pin guide comprises an upwardly open aperture to admit engagement and disengagement of the transverse pin.

7. The device of claim 5, wherein the pin guide captures the transverse pin preventing disengagement.

8. A device, comprising:
a mud flap;
a first member comprising a lower vertical plate sized to attach to an upper portion of the mud flap formed and comprising an upper outwardly extending portion with an upper gripping flange;
a second member comprising a lower vertical plate attachable to the lower vertical plate of the first member and comprising an upper outwardly extending portion with an upper gripping flange; and
attachments drawing the lower vertical plates of the first and second members to cause the opposing upper gripping flanges to engage a lower horizontal plate of an I-beam support.

9. The device of claim 8, wherein the attachments comprise bolts and nuts sized to space the lower vertical plates of the first and second member to engage an enlarged I-beam lower horizontal plate.

10. The device of claim 8, wherein the attachments comprise a lower pivotal attachment between the first and second members and a fastener attached between the first and second members.

11. The device of claim 10, wherein the pivotal attachment comprises a pin guide extending from the first member capturing a transverse pin at a lower end of the second member.

12. The device of claim 11, wherein the pin guide comprises an upwardly open aperture to admit engagement and disengagement of the transverse pin.

13. The device of claim 1 1, wherein the pin guide captures the transverse pin preventing disengagement.

14. A method for replacing a missing mud flap with hand tools, comprising:
providing a first member comprising a lower vertical plate attached to an upper portion of a mud flap;
attaching a lower portion of a second member to the first member; drawing opposing upper gripping flanges of the first and second members toward each other onto opposite sides of an I-beam transversely provided on an underside of a trailer; and
attaching the first member to the second member with a fastener to maintain the attachment to the I-beam.

15. The method of claim 14, wherein attaching the lower portion of the second member to the first member comprises attaching a second fastener to both members.

16. The method of claim 14, wherein attaching the lower portion of the second member to the first member comprises engaging a pivot portion of the second member to a pivot fixture of the first member.
